(19) United States
(12) Patent Application Publication
(10) Pub. No.: US 2026/0050431 A1
(43) Pub. Date: Feb. 19, 2026

(54) P2P IMAGE DISTRIBUTION

(71) Applicant: CAST AI Group, Inc., Miami, FL (US)

(72) Inventor: Michael NORGATE, Chichester (GB)

(21) Appl. No.: 19/056,234

(22) Filed: Feb. 18, 2025

Related U.S. Application Data
(60) Provisional application No. 63/684,043, filed on Aug. 16, 2024.

(51) Int. Cl. G06F 8/61

(52) U.S. Cl. CPC G06F 8/63

(57) ABSTRACT

A computer-implemented method of pulling container images, the method comprising adding, by a processor, a new node to a multi-node cluster that includes worker nodes deployed across availability zones, wherein the new node is deployed in a first availability zone; and pulling, by the processor, container images from a first subset of the worker nodes deployed in the first availability zone, and providing the pulled container images to the new node.

### CROSS-REFERENCE TO RELATED APPLICATIONS

This application claims priority under 35 USC § 119(e) to U.S. Provisional Application Nos. 63/684,043, filed on Aug. 16, 2024, the contents of which are incorporated herein by reference in their entirety.

### BACKGROUND

### Field

The present disclosure is generally directed to a method and a system for pulling container images.

### Related Art

Peer-to-peer (P2P) computing/networking is a distributed architecture where peers, a collection of devices/computers, communicate and share resources without a centralized server. Each device/computer acts as both a server and a client for supplying and receiving files, with bandwidth and processing capabilities distributed among all members/peers of the network. When a participating device/computer fails, the remaining devices/computers of the P2P network continue to operate without any disruption or compromise. Resources are used more efficiently in a P2P network than a traditional network, and is less susceptible to systemic failure.

FIG. 1 illustrates a conventional P2P architecture 100. As illustrated in FIG. 1, the P2P architecture 100 may include components such as a cluster 110, nodes 120, and pods 130. Within the P2P network, one or more application containers (executable unit of software for packaging and running an application) may be grouped into pods 130. One or more pods 130 run on a higher structure known as the node 120, which is an individual device/computer on the configured within the cluster 110. Cluster 110 is a collection of nodes 120 and performs automated workload distribution among the nodes 120.

A container image is a static file that contains all the necessary components for creating a container, and is stored at a container registry where container images are managed. By uploading a container image into a container registry, the container image is pushed into the container registry and available to be pulled/downloaded for later use. When a new node is added to a cluster, a container image would need to be pulled onto that node before any work can be performed. Container image pulling allows containers to be deployed consistently/replicated across nodes, making it easy to scale and reproduce the application environment. This process can take time, which increases the time pods spend in a pending state, which is especially true for large images.

Container images stored in a container registry may be replicated over a number of geographical regions. This allows faster access to the container images when containers are being deployed in the various regions, which minimizes network latency involved when container images are being pulled. In addition, container images can also be stored in a number of availability zones within a region. An availability zone is a number of physically isolated/separated data centers within relatively nearby geographic locations. Each data center in an availability zone is designed to operate even if one or more other data centers fail within the same availability zone.

With evictor and rebalancing, the chances of a pod being moved to a node that has not previously run that container image is increased, which further increases time spent in the pending state. An evictor identifies underutilized nodes as candidates for eviction, and compacts pods into fewer nodes to remove the underutilized nodes to promote operation efficiency. Rebalancing allows suboptimal nodes to be automatically replaced with updated nodes that are more cost-efficient.

For users, a number of problems exist when it comes to scaling and deployment: horizontal scaling latency, CPU cost, and networking cost.
1. Horizontal scaling latency: When scaling an application, the time taken for the new pods to come online and start processing can make a big difference in their ability to handle an increase in load.
2. CPU Cost: In order to maximize the efficiency of a cluster, it is desirable to spend as much time as possible performing meaningful work. Thus, time spent waiting for images to be downloaded/pulled could drastically impact cluster efficiency.
3. Networking cost: A networking cost may incur each time an image is pulled from the container registry, regardless whether pulling is performed across regions or availability zones.

### SUMMARY

In an embodiment, a method for pulling container images comprises: adding, by a processor, a new node to a multi-node cluster that includes worker nodes deployed across availability zones, wherein the new node is deployed in a first availability zone; and pulling, by the processor, container images from a first subset of the worker nodes deployed in the first availability zone, and providing the pulled container images to the new node.

In some embodiments, the container images are pulled concurrently to the new node.

In some embodiments, the processor is configured to pull the container images by: splitting each of the container images into corresponding spliced container images; and pulling the spliced container images.

In some embodiments, the spliced container images are pulled without performing compression on the spliced container images.

The method may further comprise, for the worker nodes not deployed in the first availability zone, pulling, by the processor, the container images from a second subset of the worker nodes deployed in a second availability zone closest to the first availability zone, from the availability zones. In some embodiments, the processor is configured to pull the container images by: splitting each of the container images into corresponding spliced container images; and pulling the spliced container images. In some embodiments, the spliced container images are pulled without performing compression on the spliced container images.

In an embodiment, a non-transitory computer readable medium storing computer executable code for pulling container images, the code when executed by a processor causes the processor to: add a new node to a multi-node cluster that includes worker nodes deployed across availability zones, wherein the new node is deployed in a first availability zone; and pull container images from a first subset of the worker nodes deployed in the first availability zone, and providing the pulled container images to the new node.

In some embodiments, the container images are pulled concurrently to the new node.

In some embodiments, the processor is configured to pull the container images by: splitting each of the container images into corresponding spliced container images; and pulling the spliced container images.

In some embodiments, the spliced container images are pulled without performing compression on the spliced container images.

In some embodiments, the processor is further configured to: for the worker nodes not deployed in the first availability zone, pull the container images from a second subset of the worker nodes deployed in a second availability zone closest to the first availability zone, from the availability zones. In some embodiments, the processor is configured to pull the container images by: splitting each of the container images into corresponding spliced container images; and pulling the spliced container images. In some embodiments, the spliced container images are pulled without performing compression on the spliced container images.

In an embodiment, a system for pulling container images comprises: a multi-node cluster that includes worker nodes deployed across availability zones; and a processor, wherein the processor is configured to: add a new node to the multi-node cluster, wherein the new node is deployed in a first availability zone; and pull container images from a first subset of the worker nodes deployed in the first availability zone, and providing the pulled container images to the new node.

In some embodiments, the container images are pulled concurrently to the new node.

In some embodiments, the processor is configured to pull the container images by: splitting each of the container images into corresponding spliced container images; and pulling the spliced container images.

In some embodiments, the spliced container images are pulled without performing compression on the spliced container images.

In some embodiments, the processor is further configured to: for the worker nodes not deployed in the first availability zone, pull the container images from a second subset of the worker nodes deployed in a second availability zone closest to the first availability zone, from the availability zones. In some embodiments, the processor is configured to pull the container images by: splitting each of the container images into corresponding spliced container images; and pulling the spliced container images. In some embodiments, the spliced container images are pulled without performing compression on the spliced container images.

### BRIEF DESCRIPTION OF DRAWINGS

A general architecture that implements the various features of the disclosure will now be described with reference to the drawings. The drawings and the associated descriptions are provided to illustrate example embodiments of the disclosure and not to limit the scope of the disclosure. Throughout the drawings, reference numbers are reused to indicate correspondence between referenced elements.

FIG. 1 illustrates a conventional P2P architecture 100.

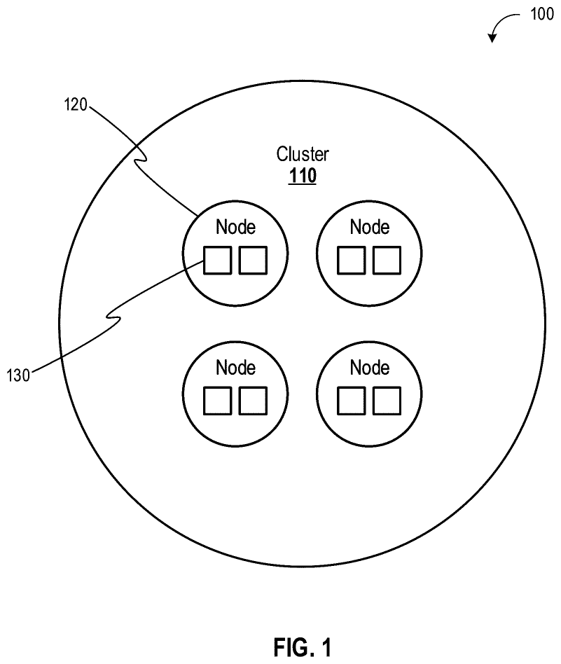

FIG. 2 illustrates an example diagram 200 for pulling container images, in accordance with an embodiment.

FIG. 3 illustrates an example diagram 300 for pulling container images, in accordance with an embodiment.

FIG. 4 illustrates an example diagram 400 for pulling container images, in accordance with an embodiment.

FIG. 5 illustrates an example computing environment with an example computer device suitable for use in some example embodiments.

### DETAILED DESCRIPTION

The following detailed description provides details of the figures and example embodiments of the present application. Reference numerals and descriptions of redundant elements between figures are omitted for clarity. Terms used throughout the description are provided as examples and are not intended to be limiting. For example, the use of the term “automatic” may involve fully automatic or semi-automatic embodiments involving user or administrator control over certain aspects of the embodiment, depending on the desired embodiment of one of the ordinary skills in the art practicing embodiments of the present application. Selection can be conducted by a user through a user interface or other input means, or can be implemented through a desired algorithm. Example embodiments as described herein can be utilized either singularly or in combination and the functionality of the example embodiments can be implemented through any means according to the desired embodiments.

Example embodiments provide a new system and method for performing container image pulling and sharing between nodes of a cluster. Networking is available at much higher bandwidth between nodes in the same availability zone. This increased bandwidth allows transfer of images at much faster speed than from a remote registry via HTTP. In addition, processing/downloading time may be further reduced by splitting the container images into small chunks/files and downloaded concurrently from multiple neighboring nodes.

In some embodiments, communication protocols such as InterPlanetary File System (IPFS), BitTorrent™, etc., may be used to facilitate storing and sharing of data/files across nodes/participating members of the P2P network. P2P image distribution may be launched by running IPFS daemon on all nodes needed to perform image sharing in the P2P network. The IPFS daemon allows access to by one node to other peers/nodes on the P2P network.

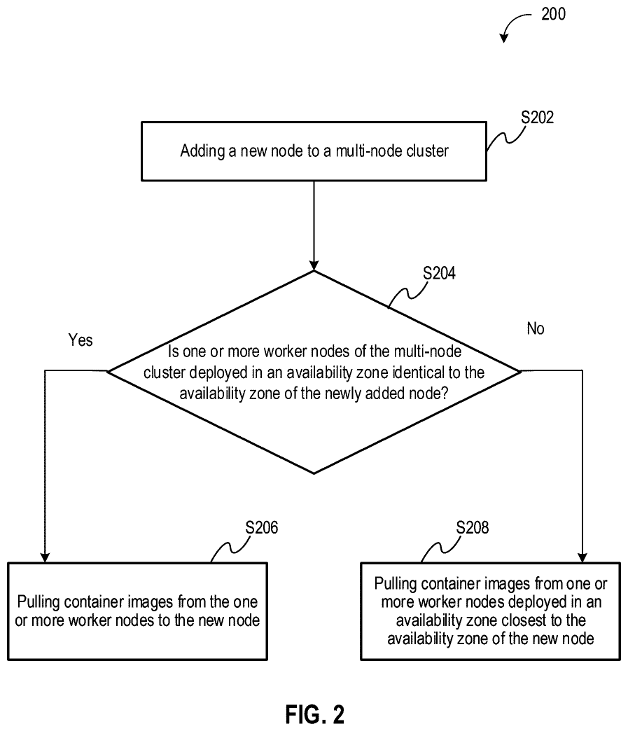

FIG. 2 illustrates an example diagram 200 for pulling container images, in accordance with an embodiment. As illustrates in FIG. 2, the process begins at step S202 where a new node is added to a multi-node cluster with worker nodes deployed across availability zones. At step S204, a determination is made as to whether one or more worker nodes of the multi-node cluster are deployed in an availability zone identical to the availability zone in which the newly added node is deployed.

If the answer is yes at step S204, then container images are pulled directly from the one or more worker nodes to the new node at step S206. By pulling the container images from the one or more worker nodes from nearby geographical areas, image transfer can be performed much faster than the traditional method of pulling container images from a remote central image repository/registry. Further, networking cost can be drastically reduced due to reduced central image repository/registry access.

In some embodiments, the container images are pulled concurrently from the worker nodes to the new node. Concurrent processing helps improve efficiency and utilization of resources, which is critical in reducing CPU costs.

If the answer is no at step S204, then container images are pulled directly from one or more worker nodes deployed in an availability zone closest to the availability zone in which the new node is deployed at step S208.

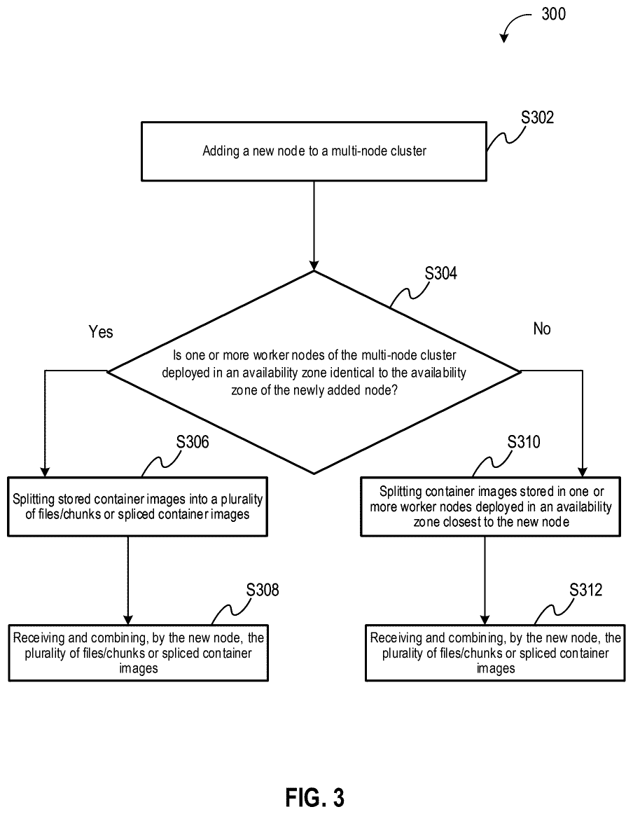

FIG. 3 illustrates an example diagram 300 for pulling container images, in accordance with an embodiment. As illustrates in FIG. 3, the process begins at step S302 where a new node is added to a multi-node cluster with worker nodes deployed across availability zones. At step S304, a determination is made as to whether one or more worker nodes of the multi-node cluster are deployed in an availability zone identical to the availability zone in which the newly added node is deployed.

If the answer is yes at step S304, then container images as stored in the one or more worker nodes are split into a plurality of files/chunks or spliced container images at step S306. Container images include components such as application code, binaries, dependencies, libraries, configuration files, and all other information/files needed for containers to run properly. Each of the components may be associated with a distinct image layer in the container image. By splitting the container images into smaller files/images (e.g., based on image layers, components, etc.), this allows container images to be transferred/shared more efficiently through faster download.

By pulling the container images from the one or more worker nodes from nearby geographical areas, image transfer can be performed much faster than the traditional method of pulling container images from a remote central image repository/registry. Further, networking cost can be drastically reduced due to reduced central image repository/registry access. At step S308 the plurality of files/chunks or spliced container images are received by the new node and combined to form the container images. In some embodiments, the plurality of files/chunks or spliced container images are further compressed before being sent to the new node. In other embodiments, the plurality of files/chunks or spliced container images are sent directly to the new node without compression. With network transfer speed already improved through image splitting and container image pulling from neighboring nodes, uncompressed images could be transferred directly to the new node with minimal delay.

If the answer is no at step S304, then container images from one or more worker nodes deployed in an availability zone closest to the availability zone in which the new node is deployed, are split into a plurality of files/chunks or spliced container images at step S310. The process then continues to step S312 where the plurality of files/chunks or spliced container images are received by the new node and combined to form the container images.

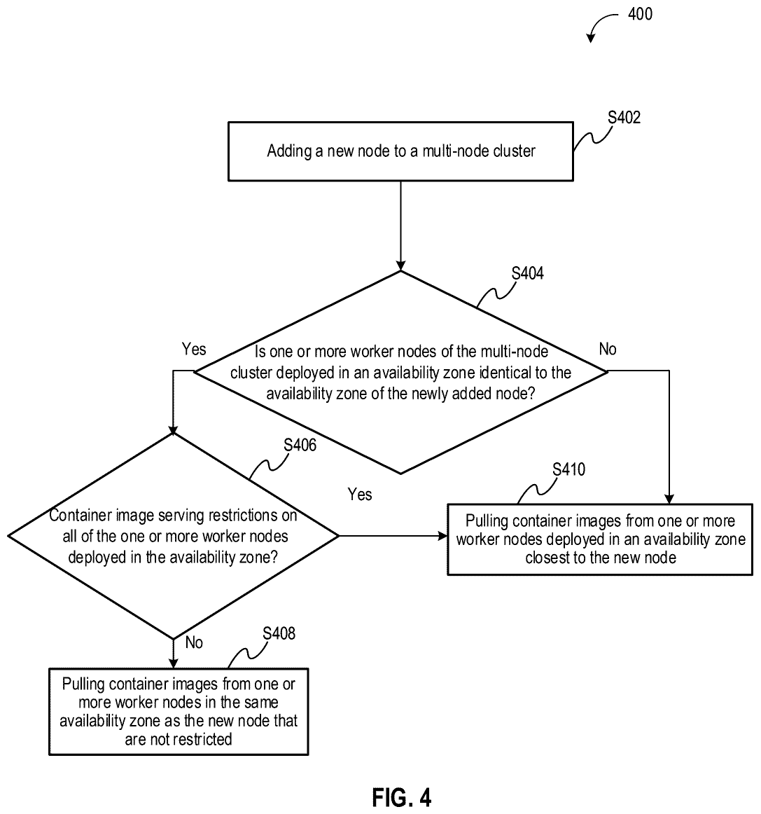

FIG. 4 illustrates an example diagram 400 for pulling container images, in accordance with an embodiment. As illustrates in FIG. 4, the process begins at step S402 where a new node is added to a multi-node cluster with worker nodes deployed across availability zones. At step S404, a determination is made as to whether one or more worker nodes of the multi-node cluster are deployed in an availability zone identical to the availability zone in which the newly added node is deployed.

If the answer is yes at step S404, a determination is made as to whether all of the one or more worker nodes deployed in the availability zone are restricted from serving container images to other nodes at S406. Access restrictions may be imposed by users/operators on nodes containing network sensitive workloads to prevent access by other nodes in the cluster. If the answer is no at step S406, container images are then pulled from one or more worker nodes in the same availability zone that are not restricted from serving container images to the new node at step S408.

By pulling the container images from the one or more worker nodes from nearby geographical areas, image transfer can be performed much faster than the traditional method of pulling container images from a remote central image repository/registry. Further, networking cost can be drastically reduced due to reduced central image repository/registry access.

If (i) the answer is no at step S404 or (ii) the answer is yes at step S406, then container images are pulled from one or more worker nodes deployed in an availability zone closest to the availability zone in which the new node is deployed at step S410.

In some embodiments, the container images are pulled concurrently from the worker nodes to the new node. Concurrent processing helps improve efficiency and utilization of resources, which is critical in reducing CPU costs.

The foregoing example implementations may have various benefits and advantages. For example, by pulling container images from neighboring nodes in the same cluster, overall bandwidth can be optimized, which significantly reduces computing resources needed/consumed for retrieving container images. Specifically, by being availability zone aware, image download from local nodes can be prioritized, which avoids performing image downloads from nodes in other availability zones.

Further, by pulling the container images from the one or more worker nodes from nearby geographical areas, image transfer time can be drastically reduced. Specifically, image transfer can be performed much faster than the traditional method when container images are pulled from neighboring nodes instead of a distant remote central image repository/registry.

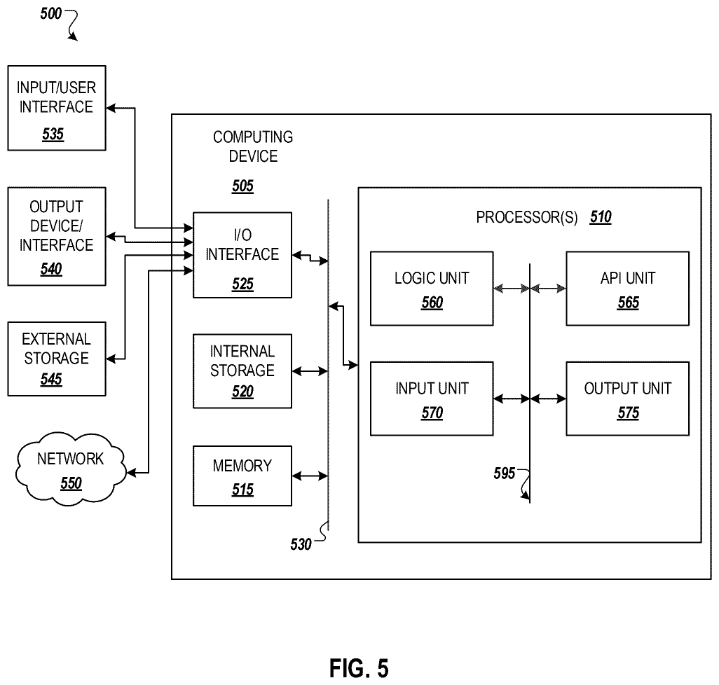

FIG. 5 illustrates an example computing environment with an example computer device suitable for use in some example embodiments. Computer device 505 in computing environment 500 can include one or more processing units, cores, or processors 510, memory 515 (e.g., RAM, ROM, and/or the like), internal storage 520 (e.g., magnetic, optical, solid-state storage, and/or organic), and/or IO interface 525, any of which can be coupled on a communication mechanism or bus 530 for communicating information or embedded in the Computer device 505. IO interface 525 is also configured to receive images from cameras or provide images to projectors or displays, depending on the desired embodiment.

Computer device 505 can be communicatively coupled to input/user interface 535 and output device/interface 540. Either one or both of the input/user interface 535 and output device/interface 540 can be a wired or wireless interface and can be detachable. Input/user interface 535 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 540 may include a display, television, monitor, printer, speaker, braille, or the like. In some example embodiments, input/user interface 535 and output device/interface 540 can be embedded with or physically coupled to the Computer device 505. In other example embodiments, other computer devices may function as or provide the functions of input/user interface 535 and output device/interface 540 for a Computer device 505.

Examples of Computer device 505 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 505 can be communicatively coupled (e.g., via IO interface 525) to external storage 545 and network 550 for communicating with any number of networked components, devices, and systems, including one or more computer devices of the same or different configuration. Computer device 505 or any connected computer device can be functioning as, providing services of, or referred to as a server, client, thin server, general machine, special-purpose machine, or another label.

IO interface 525 can include but is not limited to, wired and/or wireless interfaces using any communication or IO protocols or standards (e.g., Ethernet, 802.11x, Universal System Bus, WiMax, modem, a cellular network protocol, and the like) for communicating information to and/or from at least all the connected components, devices, and network in computing environment 500. Network 550 can be any network or combination of networks (e.g., the Internet, local area network, wide area network, a telephonic network, a cellular network, satellite network, and the like).

Computer device 505 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 505 can be used to implement techniques, methods, applications, processes, or computer-executable instructions in some example computing environments. Computer-executable instructions can be retrieved from transitory media and stored on and retrieved from non-transitory media. The executable instructions can originate from one or more of any programming, scripting, and machine languages (e.g., C, C++, C #, Java, Visual Basic, Python, Perl, JavaScript, and others).

Processor(s) 510 can execute under any operating system (OS) (not shown), in a native or virtual environment. One or more applications can be deployed that include logic unit 560, application programming interface (API) unit 565, input unit 570, output unit 575, and inter-unit communication mechanism 595 for the different units to communicate with each other, with the OS, and with other applications (not shown). The described units and elements can be varied in design, function, configuration, or embodiment and are not limited to the descriptions provided. Processor(s) 510 can be in the form of hardware processors such as central processing units (CPUs) or in a combination of hardware and software units.

In some example embodiments, when information or an execution instruction is received by API unit 565, it may be communicated to one or more other units (e.g., logic unit 560, input unit 570, output unit 575). In some instances, logic unit 560 may be configured to control the information flow among the units and direct the services provided by API unit 565, the input unit 570, the output unit 575, in some example embodiments described above. For example, the flow of one or more processes or embodiments may be controlled by logic unit 560 alone or in conjunction with API unit 565. The input unit 570 may be configured to obtain input for the calculations described in the example embodiments, and the output unit 575 may be configured to provide an output based on the calculations described in example embodiments.

Processor(s) 510 can be configured to add a new node to a multi-node cluster that includes worker nodes deployed across availability zones, wherein the new node is deployed in a first availability zone as illustrated in FIGS. 2-4. The processor(s) 510 may also be configured to pull container images from a first subset of the worker nodes deployed in the first availability zone, and providing the pulled container images to the new node as illustrated in FIGS. 2-4.

The processor(s) 510 may also be configured to pull the container images concurrently to the new node as illustrated in FIGS. 2-4.

The processor(s) 510 may also be configured to split each of the container images into corresponding spliced container images as illustrated in FIG. 3. The processor(s) 510 may also be configured to pull the spliced container images as illustrated in FIG. 3.

The processor(s) 510 may also be configured to pull the spliced container images without performing compression on the spliced container images as illustrated in FIG. 3.

The processor(s) 510 may also be configured to, for the worker nodes not deployed in the first availability zone, pull the container images from a second subset of the worker nodes deployed in a second availability zone closest to the first availability zone, from the availability zones as illustrated in FIGS. 2-4. The processor(s) 510 may also be configured to split each of the container images into corresponding spliced container images; and pulling the spliced container images as illustrated in FIG. 3. The processor(s) 510 may also be configured to pull the spliced container images without performing compression on the spliced container images as illustrated in FIG. 3.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example embodiments, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example embodiments may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software embodiments that involve instructions that perform the operations of the desired embodiment.

Various general-purpose systems may be used with programs and modules in accordance with the examples herein, or it may prove convenient to construct a more specialized apparatus to perform desired method steps. In addition, the example embodiments are not described with reference to any particular programming language. It will be appreciated that a variety of programming languages may be used to implement the teachings of the example embodiments as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example embodiments may be implemented using circuits and logic devices (hardware), while other aspects may be implemented using instructions stored on a machine-readable medium (software), which if executed by a processor, would cause the processor to perform a method to carry out embodiments of the present application. Further, some example embodiments of the present application may be performed solely in hardware, whereas other example embodiments may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other embodiments of the present application will be apparent to those skilled in the art from consideration of the specification and practice of the teachings of the present application. Various aspects and/or components of the described example embodiments may be used singly or in any combination. It is intended that the specification and example embodiments be considered as examples only, with the true scope and spirit of the present application being indicated by the following claims.

What is claimed is:

1. A computer-implemented method of pulling container images, the method comprising:
adding, by a processor, a new node to a multi-node cluster that includes worker nodes deployed across availability zones, wherein the new node is deployed in a first availability zone; and
pulling, by the processor, container images from a first subset of the worker nodes deployed in the first availability zone, and providing the container images to the new node.

2. The method of claim 1, wherein the container images are pulled concurrently to the new node.

3. The method of claim 1, wherein the processor is configured to pull the container images by:
splitting each of the container images into corresponding spliced container images; and
pulling the spliced container images.

4. The method of claim 3, wherein the spliced container images are pulled without performing compression on the spliced container images.

5. The method of claim 1, further comprising:
for the worker nodes not deployed in the first availability zone, pulling, by the processor, the container images from a second subset of the worker nodes deployed in a second availability zone closest to the first availability zone, from the availability zones.

6. The method of claim 5, wherein the processor is configured to pull the container images by:
splitting each of the container images into corresponding spliced container images; and
pulling the spliced container images.

7. The method of claim 6, wherein the spliced container images are pulled without performing compression on the spliced container images.

8. A non-transitory computer readable medium, storing instructions for pulling container images, the instructions comprising:
adding a new node to a multi-node cluster that includes worker nodes deployed across availability zones, wherein the new node is deployed in a first availability zone; and
pulling container images from a first subset of the worker nodes deployed in the first availability zone, and providing the container images to the new node.

9. The non-transitory computer readable medium of claim 8, wherein the container images are pulled concurrently to the new node.

10. The non-transitory computer readable medium of claim 8, wherein the pulling container images comprises:
splitting each of the container images into corresponding spliced container images; and
pulling the spliced container images.

11. The non-transitory computer readable medium of claim 10, wherein the spliced container images are pulled without performing compression on the spliced container images.

12. The non-transitory computer readable medium of claim 8, further comprising:
for the worker nodes not deployed in the first availability zone, pulling the container images from a second subset of the worker nodes deployed in a second availability zone closest to the first availability zone, from the availability zones.

13. The non-transitory computer readable medium of claim 12, wherein the pulling container images comprises:
splitting each of the container images into corresponding spliced container images; and
pulling the spliced container images.

14. The non-transitory computer readable medium of claim 13, wherein the spliced container images are pulled without performing compression on the spliced container images.

15. A system for pulling container images, the system comprising:
a multi-node cluster that includes worker nodes deployed across availability zones; and
a processor, wherein the processor is configured to:
add a new node to the multi-node cluster, wherein the new node is deployed in a first availability zone; and
pull container images from a first subset of the worker nodes deployed in the first availability zone, and providing the container images to the new node.

16. The system of claim 15, wherein the container images are pulled concurrently to the new node.

17. The system of claim 15, wherein the processor is configured to pull the container images by:
splitting each of the container images into corresponding spliced container images; and
pulling the spliced container images.

18. The system of claim 17, wherein the spliced container images are pulled without performing compression on the spliced container images.

19. The system of claim 15, further comprising:
for the worker nodes not deployed in the first availability zone, pulling, by the processor, the container images from a second subset of the worker nodes deployed in a second availability zone closest to the first availability zone, from the availability zones.

20. The system of claim 19, wherein the processor is configured to pull the container images by:
splitting each of the container images into corresponding spliced container images; and
pulling the spliced container images.
